(19) United States
(12) Patent Application Publication
(10) Pub. No.: US 2004/0078310 A1
(43) Pub. Date: Apr. 22, 2004

(54) System and method for determining a return-on-investment in a semiconductor or data storage fabrication facility

(76) Inventor: Louis Shaffer, Crolles (FR)

Correspondence Address: CARR & FERRELL LLP, 2200 GENG ROAD, PALO ALTO, CA, 94303, US

(21) Appl. No.: 10/274,251

(22) Filed: Oct. 17, 2002

(51) Int. Cl. G06F 17/60

(52) U.S. Cl. 705/35

(57) ABSTRACT

A return-on-investment (ROI) modeling system and method of the present invention calculates a return-on-investment for various scenarios in a semiconductor or data storage fabrication facility (“fab”). The ROI system and method of the present invention calculates the ROI based upon having fab operational details entered. The ROI calculation may be performed for an entire fab or a particular fab processing line. The present invention compares the ROI of a current operation with a contemplated change or set of changes. A complete set of pertinent factors having a relevant or significant impact on an accurate ROI calculation is taken into consideration. Further, the present invention determines costs associated with, for example, the installation of a new tool, downtime costs, short-loop test runs, split-lot testing, design-rule shrinks, and wafer-size changes. If a fab is not currently operating at maximum capacity, an embodiment of the invention calculates an increased capacity capability.

### BACKGROUND OF THE INVENTION

1. Field of the Invention

The present invention relates to cost-of-ownership of processing equipment, and more particularly, to determining a return-on-investment (ROI) for various pieces of equipment and processes in a semiconductor or data storage fabrication (“fab”) facility.

2. Description of the Background Art

The spiraling cost of production in semiconductor, data storage, and allied industries has driven such industries to closely track product cost-of-goods sold and to carefully evaluate any process equipment changes, process or design changes, or short-loop or split-lot test runs.

Current ROI models are capable of performing simple cost-of-ownership calculations for a single tool change or upgrading a single tool. However, current ROI models are incapable of making system-wide calculations. As an example, typical existing ROI models assume maximum operating capacity, do not take into account the cost of testing and implementing tool upgrades beyond the price of upgrade parts, and are incapable of calculating an ROI associated with a split-lot test. Furthermore, current ROI models do not consider factors such as production bottlenecks in other parts of a fab-line (i.e., tools other than a contemplated new tool for which the ROI is being calculated). Such factors can be extremely significant. For example, the tool causing the bottleneck can have a dramatic effect on the ROI for a contemplated new tool if it limits the new tool from achieving its maximum capacity.

Therefore, there is a need in the industry for an ROI modeling system that is capable of considering a complete set of pertinent factors having a relevant or significant impact on an accurate ROI calculation.

### SUMMARY OF THE INVENTION

The present invention is a system for determining a return-on-investment for a production tool change or process change in a semiconductor, data storage, or an allied industry fabrication facility. One embodiment of the present invention includes a performance engine for calculating a change in productivity based on entered current and anticipated performance data of the production tool change or a change in productivity due to the process change, a moves engine for entering substrate moves data and calculating a change in a total number of substrate moves due to the production tool change or process change, an operations engine for entering operational data and calculating a total change in operations return due to the production tool change or process change, a substrate-value engine for entering substrate performance parameter data and calculating a change in substrate revenue due to the production tool change or process change, a parts engine for entering any parts data and calculating a change in production due to an impact of any parts in the production tool change or process change, and an investment engine for entering investment data and calculating a cost of implementing the production tool change or process change.

Once the relevant data are entered and preliminary calculations are made, a revenue summary engine calculates a summation of any productivity gains. Productivity gains include the calculated change in the total number of substrate moves, the calculated total change in operations return, the calculated change in substrate revenue, and the calculated change in production due to an impact of any parts.

Finally, the revenue summary engine calculates a return-on-investment by dividing the summation of any productivity gains by a total investment amount.

The present invention additionally provides for a method for determining a return-on-investment for a contemplated production tool change or process change in a semiconductor or data storage fabrication facility.

The method steps of one embodiment include entering performance data for existing tools in a semiconductor or data storage production line, entering anticipated performance data for either the contemplated production tool change or due to the process change in the semiconductor or data storage production line, calculating a change in productivity based on the contemplated production tool change or process change, entering substrate move, operational, and substrate performance parameter data for a semiconductor or data storage fabrication process, calculating a change in a total number of substrate moves, a total change in operations return, and a change in substrate revenue due to the contemplated production tool change or process change, entering investment data and any parts data for the contemplated production tool or process change, calculating a cost of implementing the production tool change or process change, and calculating a change in production due to an impact of any parts in the production tool change or process change.

After relevant data are entered and preliminary calculations are made, another calculation is made, based upon the entered data preliminary calculations, of a summation of productivity gains. The summation of productivity gains includes the calculated change in the total number of substrate moves, the calculated total change in operations return, the calculated change in substrate revenue, and the calculated change in production due to the impact of any parts.

Finally, a calculation of return-on-investment is performed by dividing the summation of productivity gains by a total investment amount.

### BRIEF DESCRIPTION OF THE FIGURES

FIG. 1 is an overview diagram of an embodiment of the present invention for analysis of return-on-investment calculations;

FIG. 2A is an exemplary block diagram of various modules of a performance engine of FIG. 1;

FIG. 2B is an exemplary implementation of the performance engine of FIG. 2A as a template running under Microsoft® Excel;

FIG. 3A is an exemplary block diagram of various modules of a moves engine of FIG. 1;

FIG. 3B is an exemplary implementation of the moves engine of FIG. 3A as a template running under Microsoft® Excel;

FIG. 4A is an exemplary block diagram of various modules of an operations engine of FIG. 1;

FIG. 4B is an exemplary implementation of the operations engine of FIG. 4A as a template running under Microsoft® Excel;

FIG. 5A is an exemplary block diagram of various modules of a substrate-value engine of FIG. 1;

FIG. 5B is an exemplary implementation of the substrate-value engine of FIG. 5A as a template running under Microsoft® Excel;

FIG. 6A is an exemplary block diagram of various modules of a parts engine of FIG. 1;

FIG. 6B is an exemplary implementation of the parts engine of FIG. 6A as a template running under Microsoft® Excel;

FIG. 7A is an exemplary block diagram of various modules of an investment engine of FIG. 1;

FIG. 7B is an exemplary implementation of the investment engine of FIG. 7A as a template running under Microsoft® Excel;

FIG. 8A is an exemplary block diagram of various modules of a revenue and ROI summary engine of FIG. 1;

FIG. 8B is an exemplary implementation of the revenue and ROI summary engine of FIG. 8A as a template running under Microsoft® Excel;

FIG. 9A is an exemplary block diagram of various modules of an optional general summary engine of FIG. 1;

FIG. 9B is an exemplary implementation of the optional general summary engine of FIG. 9A as a template running under Microsoft® Excel;

FIG. 10A is an exemplary implementation of an optional help notes engine of FIG. 1;

FIG. 10B is an exemplary implementation of the optional help notes engine of FIG. 10A as a template running under Microsoft® Excel;

FIG. 11 is a flowchart of an exemplary method for inputting and calculating various return-on-investment calculations; and

FIG. 12 is a flowchart detailing an exemplary return-on-investment calculation of FIG. 11.

### DESCRIPTION OF PREFERRED EMBODIMENTS

A return-on-investment (ROI) modeling system of the present invention calculates a return-on-investment for various scenarios in a semiconductor, data storage, or an allied industry fabrication facility (hereinafter referred to as a semiconductor or data storage fabrication facility, or “fab”). There are a number of major areas where a return-on-investment (ROI) modeling system is useful for calculating an accurate ROI for a contemplated change in a fab, including:

calculating a return for a single production tool change (either adding a new tool or replacing an existing tool) while considering the effect of other production tools/processes in the fab-line on the single tool change;

calculating a return for a burdened single tool change incorporating relevant internal and external incurred expenses;

calculating a return to upgrade an existing tool or set of tools while considering the effect of other production tools/processes in the fab-line on the upgrade;

calculating a return for a burdened upgrade incorporating relevant internal and external incurred expenses;

calculating a return on a contemplated process change while considering the effect of other production tools/processes in the fab-line on the process change or calculating the return for a burdened process change incorporating relevant internal and external incurred expenses; and

calculating a return for a potential increased fab or fab-line capacity while considering the limiting effects on actual capacity increase such as required preventive maintenance (PM) downtime and critical path production bottlenecks.

The modeling system of the present invention calculates ROI based upon having fab operational details entered. The ROI calculation may be performed for an entire fab or a particular fab processing line. The fab processing line being evaluated may be used for producing saleable product or may be used for producing non-saleable product, such as a product produced from short-loop or R&D test-runs. Additionally, the production line being evaluated by the present invention may be a separate line, such as a non-revenue generating line or R&D test line.

The present invention compares the ROI of a current operation with a contemplated change or set of changes, as described above. A complete set of pertinent factors having a relevant or significant impact on an accurate ROI calculation is taken into consideration. Further, the present invention determines costs associated with, for example, the installation of a new tool (e.g., installation labor-costs, consumable materials used during testing, impact on other peripheral tools needed for test such as lithography and etch bays, training costs, etc.), downtime costs (e.g., lost productivity, labor-costs to return to an operational state, repair or replacement parts, etc.), short-loop test runs, split-lot testing, design-rule shrinks, and wafer-size changes (e.g., a 200 mm to 300 mm change).

If a fab is not currently operating at maximum capacity, an embodiment of the invention calculates an increased capacity capability. An increased capacity capability calculation may be non-intuitive since capacity will frequently not scale linearly with an assumed throughput increase (e.g., a planned capacity increase from 50% to 100% will seldom produce twice as much product). This non-linear scaling is due to factors such as additional PM required (especially since such PM's require a planned downtime), and production bottlenecks caused by other tools in a fab-line.

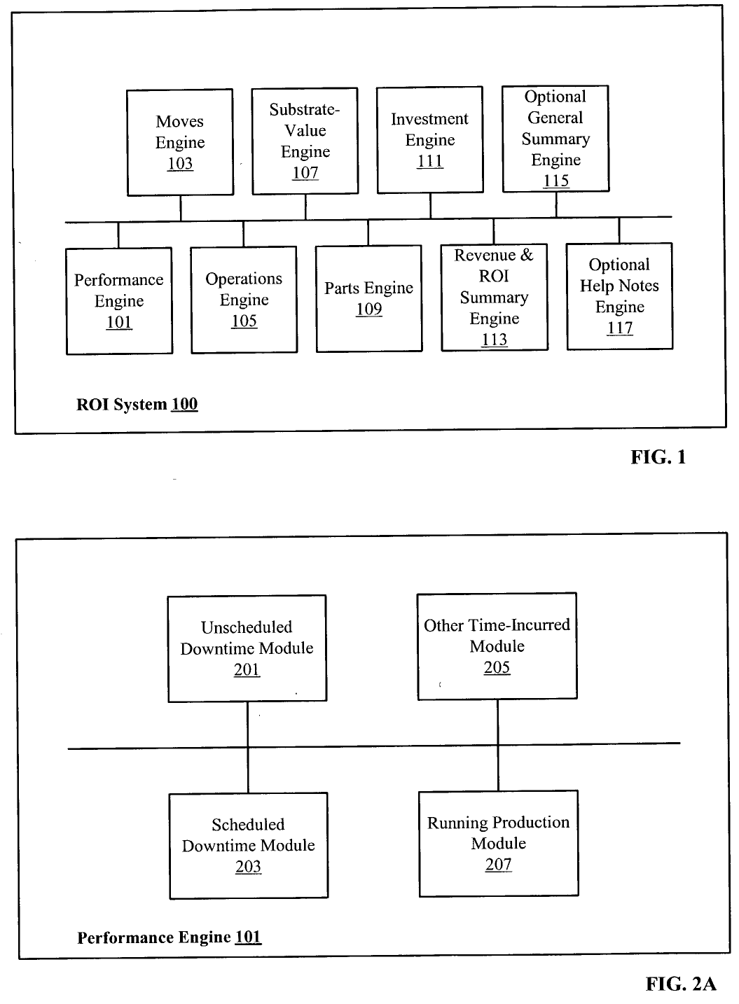

FIG. 1 is an exemplary overview diagram of an embodiment of the present invention showing a return-on-investment (ROI) system 100. As shown, various analysis engines are part of the ROI system 100. These engines include a performance engine 101, a moves engine 103, an operations engine 105, a substrate-value engine 107, a parts engine 109, an investment engine 111, a revenue and ROI summary engine 113, an optional general summary engine 115, and an optional help notes engine 117. A system bus allows any values entered or calculated by any of the engines to be shared amongst all engines.

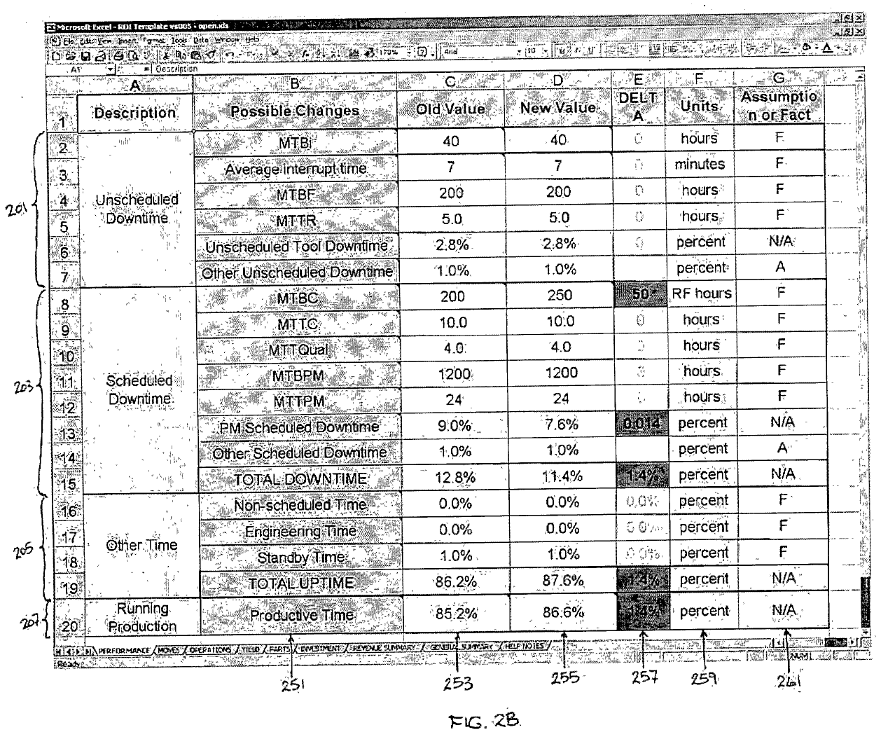

The performance engine 101 calculates uptime, downtime, and productive-time percentages for a fab tool based on various performance parameters for the tool. The moves engine 103 determines the number of times a substrate, such as a semiconductor wafer or disk media, must pass through a production tool, based on values such as a total number of chambers, a number of planned moves per unit time, and a raw tool throughput. The operations engine 105 determines a periodic total operations return based on a combination of saved labor-costs and saved substrate-costs. The substrate-value engine 107 determines the total substrate-return per unit time based on a combination of reduced substrate scrap rate, the number of chambers, and a revenue per substrate pass. The parts engine 109 determines a total parts return-rate based on a periodic cost of parts, a cost of consumable parts, and a cost of parts changed on each tool cleaning. The investment engine 111 determines a total project investment cost based on consumables, burdened labor-costs, machine time to implement changes, and other related expenditures. The revenue and ROI summary engine 113 determines a periodic impact on overall productivity based on output revenue per unit time, total operations return per unit time, total substrate-return per unit time, and total parts return per unit time. The optional general summary engine 115 displays user or fab information, labor-savings, substrate-cost savings, overall parts-savings, changes in periodic substrate moves, change in yield, and scrap reduction. The optional help notes engine 117 displays general information to a user of the ROI system 100. General information may include overview information on the use of the ROI system 100, definitions of less well-known terms, or general indications of how and why calculations are performed. Any of these help notes may be viewed as a textual display, or, optionally, may be in the form of context-sensitive help notes. Further descriptions of required or preferred inputs and calculations performed by these various engines are described in greater detail in connection with FIGS. 2B-12, infra.

The ROI system 100 may be implemented in software (e.g., a program written in C++ and executed on a workstation or personal computer), hardware (e.g., one or more engines may be a dedicated logic circuit such as an ASIC device coupled to an appropriate input and output device), or as a template for a spreadsheet program (e.g., Microsoft® Excel).

FIG. 2A is an exemplary block diagram of the performance engine 101 of FIG. 1. The performance engine 101 calculates a change in productivity for a fab tool including uptime, downtime, and productive-time percentages for the fab tool based on various performance parameters entered for the fab tool. The performance engine 101 includes an unscheduled downtime module 201, a scheduled downtime module 203, a module for other time incurred 205, and a running production module 207.

The unscheduled downtime module 201 calculates an unscheduled tool downtime percentage based on user-input values such as mean time between interrupt, average interrupt time, mean time between failures, and mean time to repair. The scheduled downtime module 203 calculates a scheduled tool downtime percentage based on user-input values such as mean time between cleans, mean time to clean, mean time between planned maintenance, and mean time to perform PM. The other incurred-time module 205 calculates a total uptime percentage based on the user-input values of engineering and standby time and a calculated value of productive time. The running production module 207 calculates a productive time percentage based on the user-input values of other unscheduled downtime, other scheduled downtime, engineering time, and standby time and the calculated values of PM scheduled downtime and unscheduled tool downtime. Each of these various modules is described in greater detail in connection with FIG. 2B.

FIG. 2B shows a screen shot of an exemplary embodiment of the performance engine 101 of FIG. 1 in the form of a Microsoft® Excel spreadsheet and shows further details of user-inputs and calculated values. Calculations performed within this embodiment of the performance engine 101 are described further herein. This embodiment of the performance engine 101 includes an exemplary unscheduled downtime module 201, an exemplary scheduled downtime module 203, an exemplary other incurred-time module 205, an exemplary running production module 207, a column 251 listing performance parameters, a column 253 for user-input data of an old or current set of performance parameter values, a column 255 for user-input data of a new or contemplated set of performance parameter values, a column 257 calculating and displaying a difference in value between the old and new performance parameters, a column 259 indicating units of the performance parameters, and a column 261 to indicate if any individual rows constitute an assumption or fact of the column 251 listing performance parameters.

The exemplary unscheduled downtime module 201 calculates an unscheduled tool downtime percentage based on user-input values. Within the unscheduled downtime module 201, the performance parameters column 251 lists user-input values of mean time between interrupt (MTBi), average interrupt time, mean time between failure (MTBF), mean time to repair (MTTR), unscheduled tool downtime, and other unscheduled downtime.

The exemplary scheduled downtime module 203 calculates a scheduled tool downtime percentage based on user-input values. Within the scheduled downtime module 203, the performance parameters column 251 lists user-input values for mean time between cleans (MTBC), mean time to clean (MTTC), mean time to qualification (MTTQual, calculated after cleaning has been performed), mean time between planned maintenance (MTBPM), mean time to perform preventive maintenance (MTTPM), and other scheduled downtime. The scheduled downtime module 203 calculates a preventive maintenance (PM) scheduled downtime percentage based on the user-input values. Additionally, a total downtime percentage value is calculated based on the calculated unscheduled tool downtime and the value of user-input other unscheduled downtime.

The exemplary other incurred-time module 205 calculates a total uptime percentage based on the user-input values of engineering and standby time and a calculated value of productive time (described below). Within the other incurred-time module 205, the performance parameters column 251 lists user-inputs of non-scheduled time, engineering time, and standby time.

The running production module 207 calculates a productive time percentage based on the user-input values of other unscheduled downtime, other scheduled downtime, engineering time, and standby time and the calculated values of PM scheduled downtime and unscheduled tool downtime.

The assumption or fact column 261 provides a convenient means for a user to input and readily identify if factual or assumed user-input values are entered into any cell in either the old or current set of performance parameter values column 253 or the new or contemplated set of performance parameter values column 255.

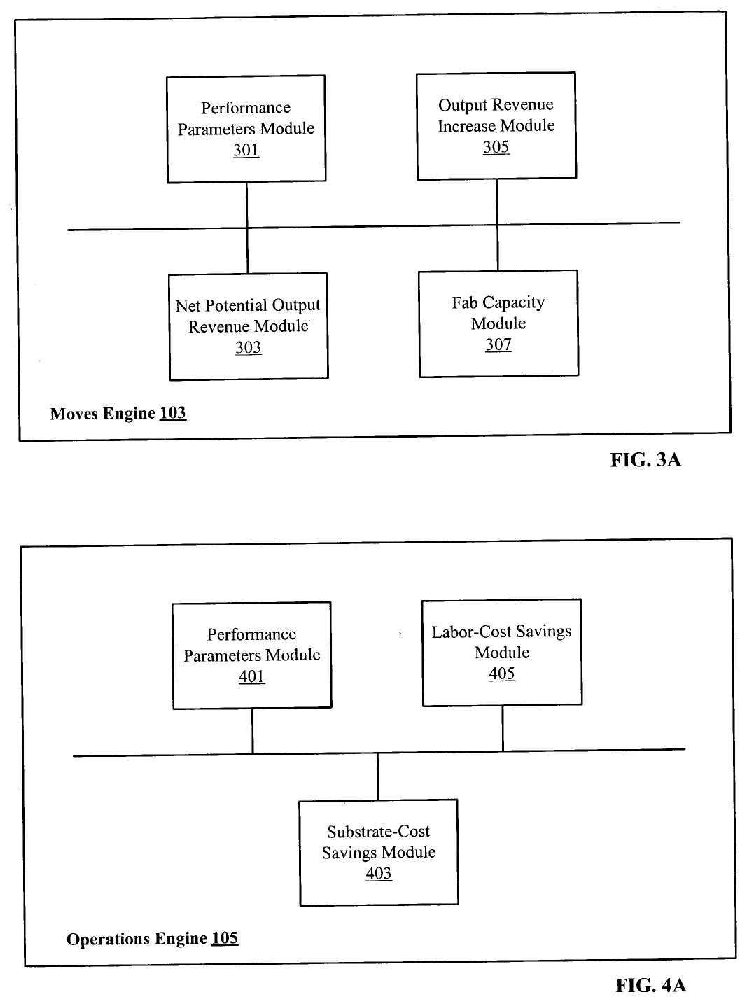

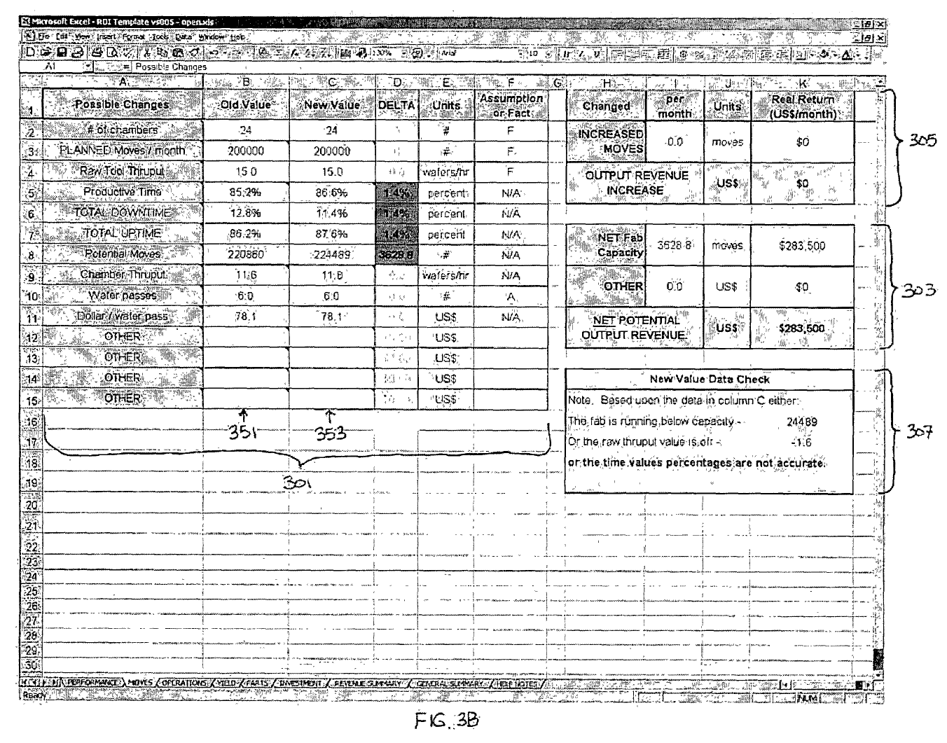

FIG. 3A is an exemplary block diagram of the moves engine 103 of FIG. 1. The moves engine 103 determines a first productivity gain of output revenue change based on a total number of times a substrate, such as a semiconductor wafer or disk media, must pass through a production tool. For example, for four metal layers to be deposited on a substrate, the substrate makes four moves through one or more deposition tools. The moves engine 103 includes a performance parameters module 301, a net potential output revenue module 303, an output revenue increase module 305, and a fab capacity module 307.

The performance parameters module 301 calculates a total number of potential substrate moves and a chamber substrate throughput rate based on user-input values such as a total number of chambers, a number of planned moves per unit time, and a raw tool throughput. The net potential output revenue module 303 calculates a net potential output revenue based on a difference between the old and new values of the calculated value of potential substrate moves and the user-input value of planned moves per unit time, multiplied times the calculated value of revenue per substrate pass. The output revenue increase module 305 calculates an output revenue increase based on a difference between the old and new values of planned moves per unit time, multiplied times the calculated value of revenue per substrate pass. The fab capacity module 307 calculates a fab capacity based on a difference between a periodic total number of potential moves and a periodic total number of planned moves. Each of these various modules is described in greater detail in connection with FIG. 3B.

FIG. 3B shows a screen shot of an exemplary embodiment of the moves engine 103 of FIG. 1 in the form of a Microsoft® Excel spreadsheet and shows details of user-inputs and calculated values. Calculations performed within this embodiment of the moves engine 103 are described further herein. This embodiment of the moves engine 103 includes an exemplary performance parameters module 301, an exemplary net potential output revenue module 303, an exemplary output revenue increase module 305, and a fab capacity module 307.

The exemplary performance parameters module 301 of FIG. 3B calculates a total number of potential substrate moves and a chamber substrate throughput rate based on user-input values of a total number of chambers, a periodic planned number of moves, and a raw tool throughput. The exemplary performance parameters module 301 further includes a column 351 for user-input data of an old or current set of performance parameter values and a column 353 for user-input data of a new or contemplated set of performance parameter values. Other columns shown have similar functions to those described in connection with FIG. 2B.

The exemplary performance parameters module 301 calculates values for potential substrate moves and chamber throughput based on user-input values of a total number of chambers (for example, as found in a multi-chamber deposition tool), a total number of planned substrate moves per unit time, and a raw tool throughput for a tool running in continuous mode. Other values shown within the exemplary performance parameters module 301 are either entered or calculated in other modules of the FIG. 1 embodiment of the present invention.

The exemplary net potential output revenue module 303 calculates a net potential output revenue based on a difference between old and new values of a calculated value of potential substrate moves and the user-input value of planned substrate moves per unit time, multiplied times the calculated value of revenue per substrate pass.

The exemplary output revenue increase module 305 calculates an output revenue increase based on a difference between the old and new values of planned moves per unit time, multiplied times the calculated value of revenue per substrate pass.

The exemplary fab capacity module 307 calculates a fab capacity based on a difference between a periodic total number of potential moves and a periodic total number of planned moves. Optionally, the exemplary fab capacity module may also calculate a percentage of maximum fab capacity by dividing the number of planned moves by the number of potential moves. The exemplary fab capacity module 307 also calculates and warns that the raw throughput value (RTV_{Δ}) may be off by subtracting the entered value of raw tool throughput from the quotient obtained by dividing the ratio of periodic planned moves to productive time by the total number of chambers as shown in the exemplary equation below:

$${RTV}_{Δ} = [ \frac{periodic planned moves / productive time}{total number of chambers} ] - [ Raw Tool Throughput ]$$

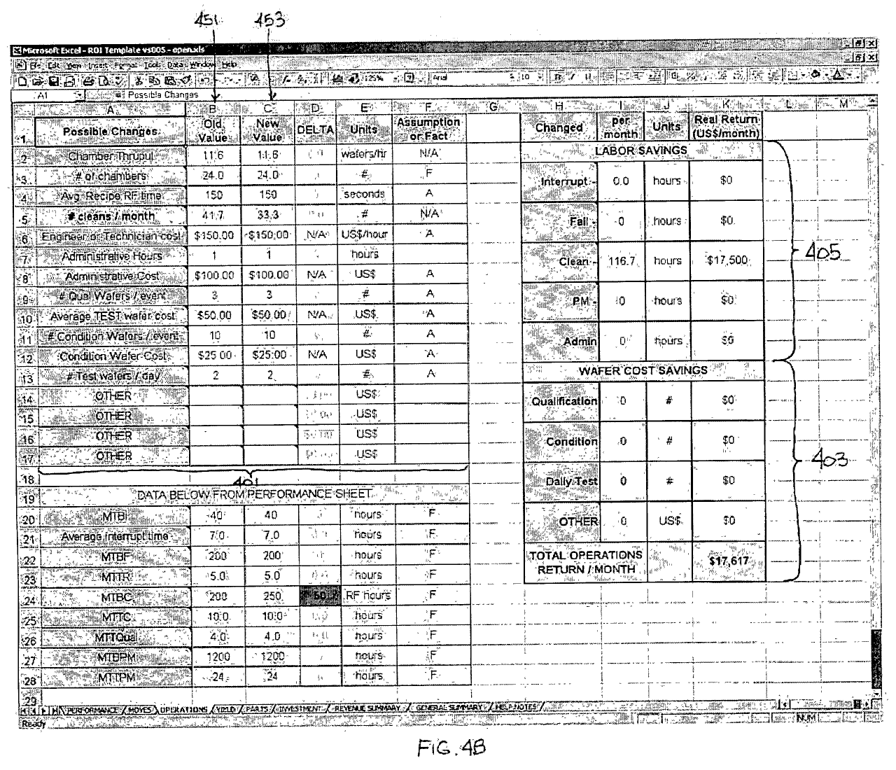

FIG. 4A is an exemplary block diagram of the operations engine 105 of FIG. 1. The operations engine 105 determines a second productivity gain of a periodic total operations return (or change in expense) based on a combination of saved labor-costs and saved substrate-costs. The operations engine 105 includes a performance parameters module 401, a substrate-cost savings module 403, and a labor-cost savings module 405.

The performance parameters module 401 calculates a total number of cleaning cycles per unit time based on the value of chamber throughput calculated in the moves engine 103, the value of number of chambers entered into the moves engine 103, and an average recipe radio-frequency (RF) time. The substrate-cost savings module 403 calculates a substrate-cost savings based on a difference between old and new values of various substrate types used, multiplied times the average cost for a particular substrate type. The labor-cost savings module 405 calculates a labor-cost savings based on a difference between old and new values of labor hours, multiplied times an associated labor rate. Each of these various modules is described in greater detail in connection with FIG. 4B.

FIG. 4B shows a screen shot of an exemplary embodiment of the operations engine 105 of FIG. 1 in the form of a Microsoft® Excel spreadsheet and shows details of user-inputs and calculated values. Calculations performed within this embodiment of the operations engine 105 are further described below. This embodiment of the operations engine 105 includes an exemplary performance parameters module 401, an exemplary substrate-cost savings module 403, and an exemplary labor-cost savings module 405.

The exemplary performance parameters module 401 of FIG. 4B calculates a total number of cleaning cycles per unit time based on the value of chamber throughput calculated in the moves engine 103, the value of number of chambers entered into the moves engine 103, and an average recipe RF time (for an average RF time per substrate that will consume parts, not the recipe time including stability steps). The exemplary performance parameters module 401 further includes a column 451 for user-input data of an old or current set of performance parameter values and a column 453 for user-input data of a new or contemplated set of performance parameter values. Other values shown within exemplary performance parameters module 401 are either entered or calculated in other modules of the FIG. 1 embodiment of the present invention. Other columns shown have similar functions to those described in connection with FIG. 2B.

The exemplary substrate-cost savings module 403 calculates a substrate-cost savings based on a difference between old and new values of various substrate types used, multiplied times the average cost for a particular substrate type.

The exemplary labor-cost savings module 405 calculates a labor-cost savings based on a difference between the old and new values of labor hours, multiplied times an associated labor rate. This savings includes engineering time related to an interrupt, fail, clean, or PM activity and administrative time for any activities related to parts ordering (e.g., actual ordering, accounts payable functions, etc.).

FIG. 5A is an exemplary block diagram of the substrate-value engine 107 of FIG. 1. The substrate-value engine 107 determines a third productivity gain of a total substrate-return per unit time (or change in total substrate revenue) based on a combination of reduced substrate scrap rate, a total number of chambers, and a revenue per substrate pass. (The revenue per substrate pass value needs to be calculated carefully. If an increase in substrate moves occurs at the same time as the revenue per substrate pass value changes, it is typical to double count the overall revenue impact to the fab.) The substrate-value engine 107 includes a performance parameters module 501 and a total substrate-return module 503.

The performance parameters module 501 calculates a value for revenue per substrate pass based on user-input values of estimated substrate scrap rate, a total number of dice per substrate, an average yield percentage, an average selling price (ASP) per die, a gross margin, and a total number of substrate passes. The total substrate-return module 503 calculates a value for a total substrate-return rate based on user-input values of scrap rate and the total number of substrate passes, the values of chamber throughput and number of chambers entered in the exemplary performance parameters module 401 (FIG. 4A), and the revenue per substrate pass. Each of these modules is described in greater detail in connection with FIG. 5B.

FIG. 5B shows a screen shot of an exemplary embodiment of the substrate-value engine 107 of FIG. 1 in the form of a Microsoft® Excel spreadsheet and shows details of user-inputs and calculated values. Calculations performed within this embodiment of the substrate-value engine 107 are described in further detail below. This embodiment of the substrate-value engine 107 includes an exemplary performance parameters module 501 and an exemplary total substrate-return module 503. The exemplary performance parameters module 501 of FIG. 5B includes a column 551 for user-input data of an old or current set of performance parameter values and a column 553 for user-input data of a new or contemplated set of performance parameter values. Other columns shown have similar functions to those described in connection with FIG. 2B.

The exemplary performance parameters module 501 calculates a revenue per substrate pass based on user-input values of estimated substrate scrap rate, a total number of dice per substrate (note that the number of dice may vary as a function of design rule, product, and/or substrate size change), average yield percentage, average selling price (ASP) per die (if applicable), gross margin (if applicable), and a total number of substrate passes (a total number of steps in a product cycle that pass through a particular tool type). Further, a user-input adjustment factor may be entered. This adjustment factor allows for an adjustment of the revenue per substrate pass so that proprietary numbers do not need to be entered directly. Other values shown within the exemplary performance parameters module 501 are either entered or calculated in other modules of the FIG. 1 embodiment of the present invention.

The total substrate-return module 503 calculates a value for a total substrate-return rate. This value is calculated from the user-input values of scrap rate and the number of substrate passes in the performance parameters module 501, the values of chamber throughput and number of chambers entered in the exemplary performance parameters module 401 (FIG. 4B), and the revenue per substrate pass.

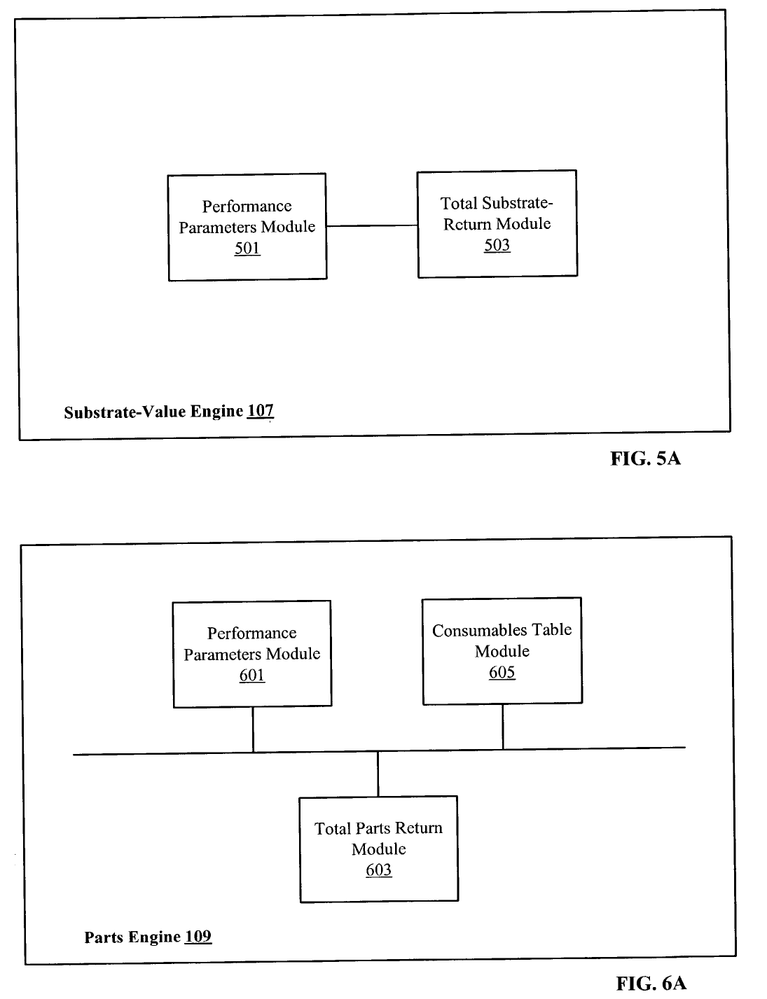

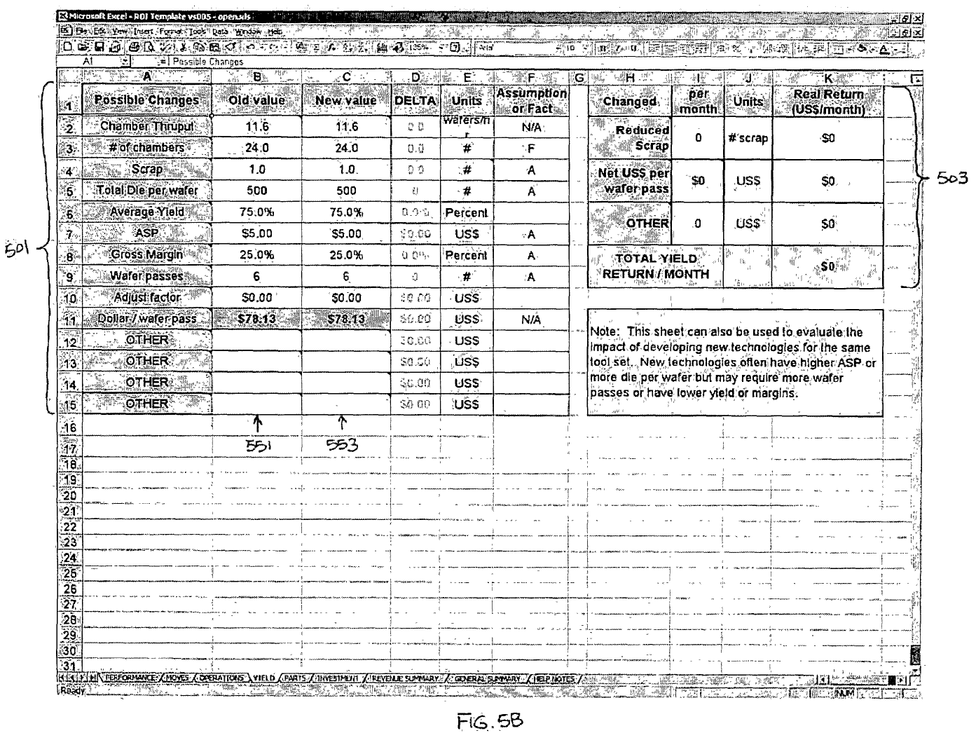

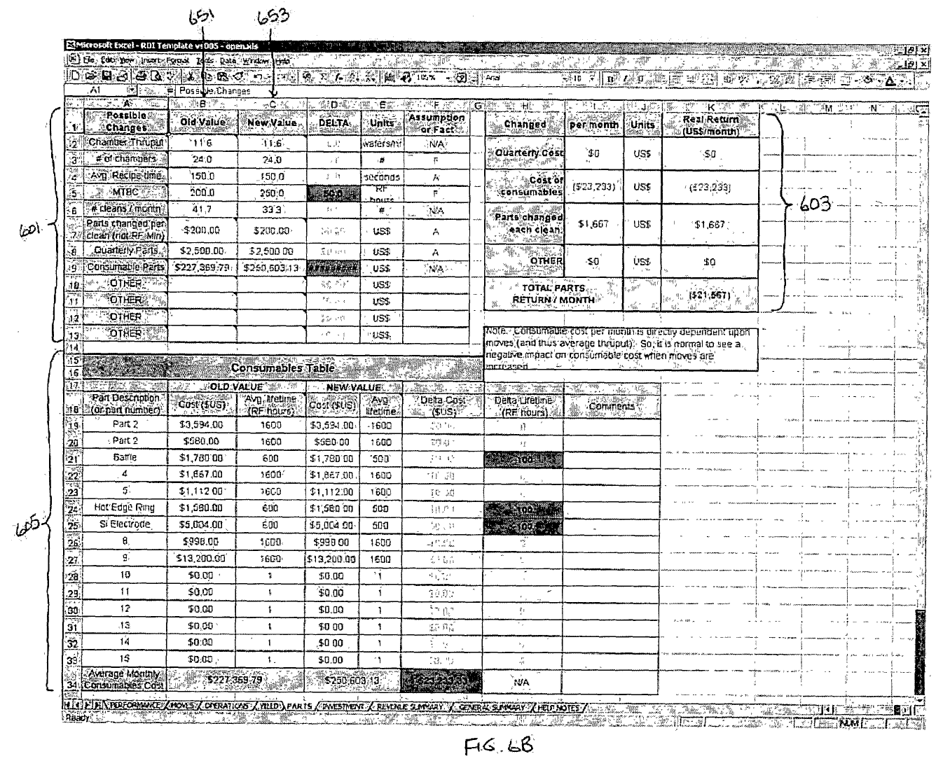

FIG. 6A is an exemplary block diagram of the parts engine 109 of FIG. 1. The parts engine 109 determines a fourth productivity gain of a total parts return rate (or change in total parts expense) based on a periodic cost of parts, a cost of consumable parts, and a cost of parts changed on each tool cleaning. The parts engine 109 includes a performance parameters module 601, a total parts return module 603, and a consumables table module 605.

The performance parameters module 601 contains user input values of parts changed per clean and a periodic PM-related parts change. The total parts return module 603 calculates a periodic total parts return based on a difference between the old and new values of periodic parts costs and cost of consumables, and a total number of parts changed per clean multiplied times a total number of cleans per unit time. The consumable tables module 605 contains user-entered values of consumable parts. Each of these various modules is described in greater detail in connection with FIG. 6B.

FIG. 6B shows a screen shot of an exemplary embodiment of the parts engine 109 of FIG. 1 in the form of a Microsoft® Excel spreadsheet and shows details of user-inputs and calculated values. Calculations performed within this embodiment of the parts engine 109 are further described below. This embodiment of the parts engine 109 includes an exemplary performance parameters module 601, an exemplary total parts return module 603, and an exemplary consumables table module 605. The exemplary performance parameters module 601 of FIG. 6B includes a column 651 for user-input data of an old or current set of performance parameter values and a column 653 for user-input data of a new or contemplated set of performance parameter values. Other columns shown have similar functions to those described in connection with FIG. 2B.

The exemplary performance parameters module 601 contains user-input values of parts changed per clean and a periodic PM-related parts change. Other values shown within the exemplary performance parameters module 601 are either entered or calculated in other modules of the FIG. 1 embodiment of the present invention. A total consumable parts cost is calculated as a summation of consumable parts entered in the exemplary consumables table module 605.

The total parts return module 603 calculates a periodic total parts return based on a difference between the old and new values of periodic parts costs and cost of consumables, and a total number of parts changed per clean multiplied times the number of cleans per unit time.

FIG. 7A is an exemplary block diagram of the investment engine 111 of FIG. 1. The investment engine 111 determines a total project investment cost (i.e., a total investment amount) based on consumables, burdened labor-costs, machine time to implement changes, and other related expenditures. The investment engine 111 includes an investments module 701 and a total project investment module 703.

The investments module 701 contains user-input values of purchased evaluation parts, machine time (i.e., the total number of hours a tool is out of production), engineering labor, and total numbers for various levels of test substrates. The total project investment module 703 calculates a total project investment cost for both estimated and actual costs. Each of these modules is described in greater detail in connection with FIG. 7B.

FIG. 7B shows a screen shot of an exemplary embodiment of the investment engine 111 of FIG. 1 in the form of a Microsoft® Excel spreadsheet and shows details of user-inputs and calculated values. Calculations performed within this embodiment of the investment engine 111 are described below. This embodiment of the investment engine 111 includes an exemplary investments module 701 and an exemplary total project investment module 703. The exemplary investments module 701 of FIG. 7B includes a column 751 for user-input data of total estimated costs and a column 753 for user-input data of actual incurred costs. Other columns shown have similar functions to those described in connection with FIG. 2B.

There are no calculations performed within the exemplary investments module 701 of FIG. 7B. Instead of making calculations, the exemplary investments module 701 contains user-input values of purchased evaluation parts, machine time (i.e., the total number of hours a tool is out of production), engineering labor, and total numbers for various levels of test substrates. Other values shown within the exemplary investments module 701 are either entered or calculated in other modules of the FIG. 1 embodiment of the present invention.

The exemplary total project investment module 703 calculates a total project investment cost for both estimated and actual costs. The estimated and actual costs are each based on total parts costs, lost machine-time production costs, a total substrate-cost, and a cost of engineering labor.

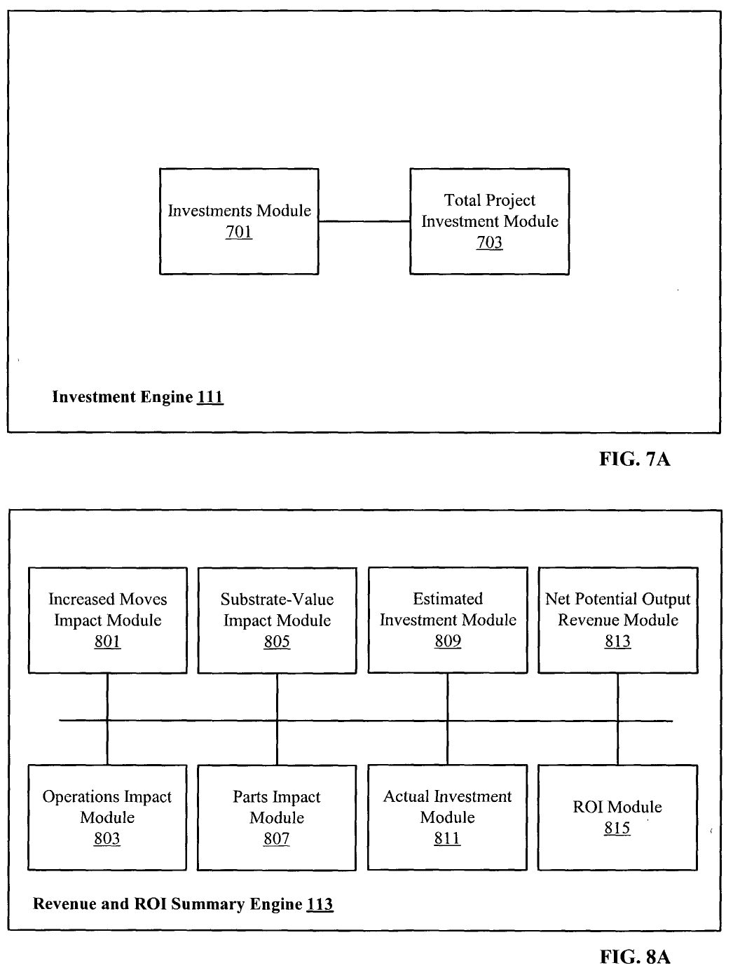

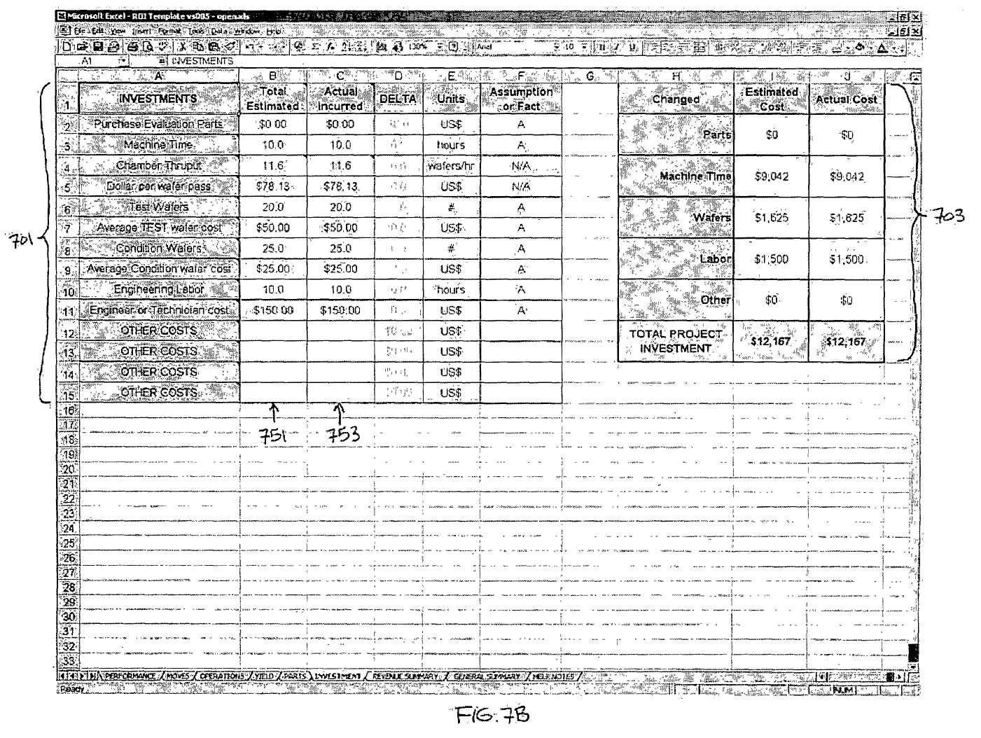

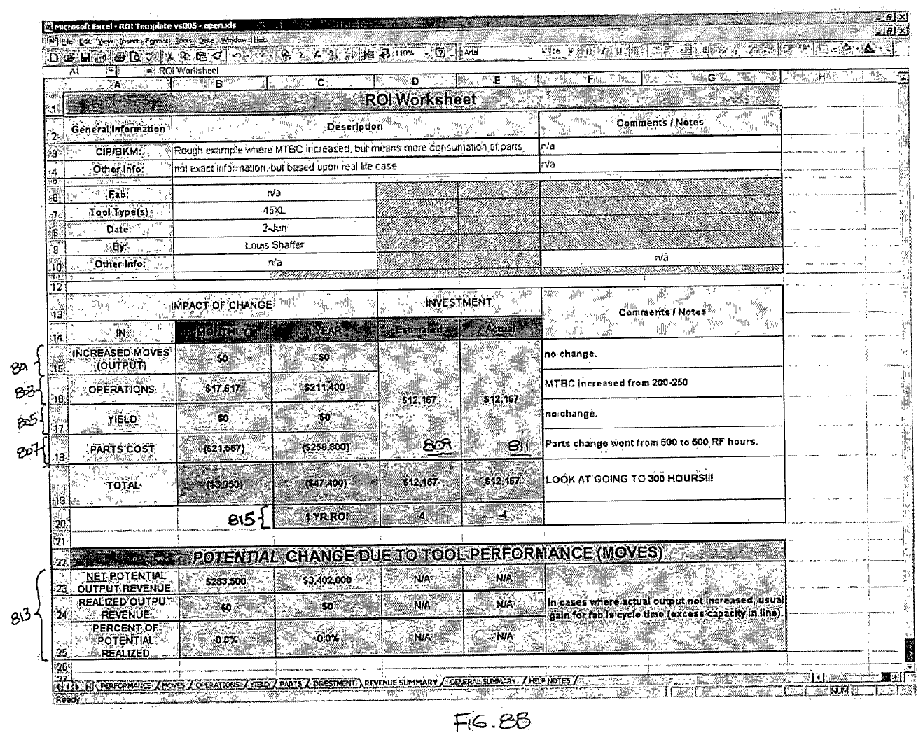

FIG. 8A is an exemplary block diagram of the revenue and ROI summary engine 113 of FIG. 1. The revenue and ROI summary engine 113 determines a periodic impact on overall productivity based on output revenue per unit time, total operations return per unit time, total substrate-return per unit time, and total parts return per unit time. The revenue and ROI summary engine 113 includes an increased moves impact module 801, an operations impact module 803, a substrate-value impact module 805, a parts impact module 807, an estimated investment impact module 809, an actual investment impact module 811, a net potential revenue module 813, and an ROI module 815.

The increased moves impact module 801, the operations impact module 803, the substrate-value impact module 805, and the parts impact module 807, comprise the four major productivity gain areas. Values shown for these four productivity gain modules are calculated in other modules of the FIG. 1 embodiment of the present invention and redisplayed for convenience. The estimated investment impact module 809 and the actual investment impact module 811 each display a value previously calculated within the exemplary total project investment module 703 (FIG. 7A). The net potential revenue module 813 calculates a percentage of potential revenue realized based on the values of net potential output revenue and realized output revenue, both calculated in the moves engine 103 (FIG. 3A). The ROI module 815 calculates both an estimated and an actual total ROI based on a sum of values from the four productivity gains divided by either the value from the estimated investment module 809 or the value from the actual investment module 811. Each of these various modules is described in greater detail in connection with FIG. 8B.

FIG. 8B shows a screen shot of an exemplary embodiment of the revenue and ROI summary engine 113 of FIG. 1 in the form of a Microsoft® Excel spreadsheet and shows details of calculated values. The exemplary revenue and ROI summary engine 113 includes an exemplary increased moves impact module 801, an exemplary operations impact module 803, an exemplary substrate-value impact module 805, an exemplary parts impact module 807, an exemplary estimated investment impact module 809, an exemplary actual investment impact module 811, an exemplary net potential revenue module 813, and an exemplary ROI module 815. Calculations performed within this embodiment of the revenue and ROI summary engine 113 are described below.

There are no calculations performed within the exemplary increased moves impact module 801, the exemplary operations impact module 803, the exemplary substrate-value impact module 805, the exemplary parts impact module 807, the exemplary estimated investment module 809, or the exemplary actual investment module 811 of the exemplary revenue and ROI summary engine 113 of FIG. 8B. Four of these modules, the exemplary increased moves impact module 801, the exemplary operations impact module 803, the exemplary substrate-value impact module 805, and the exemplary parts impact module 807, contain values that are calculated in various other engines and comprise the four major productivity gain areas. Values shown under the “Monthly” column for these four productivity gain modules are calculated in other modules of the FIG. 1 embodiment of the present invention and redisplayed for convenience. Additionally, a total periodic impact of change is calculated as a summation of the four aforementioned modules and displayed.

The exemplary estimated investment impact module 809 and the exemplary actual investment impact module 811 each display a value previously calculated within the exemplary total project investment module 703 (FIG. 7B).

The exemplary net potential revenue module 813 calculates a percentage of potential revenue realized based on the values of net potential output revenue and realized output revenue, both calculated in the exemplary moves engine 103 (FIG. 3B).

Finally, the exemplary ROI module 815 calculates both an estimated and an actual total ROI based on a sum of values from the four productivity gains divided by either the value from the exemplary estimated investment module 809 or the value from the exemplary actual investment module 811, respectively. Mathematically, the ROI calculation may be readily seen in the form of the following exemplary equation:

$$ROI = \frac{\sum Productivity Gains}{Total Investment Amount}$$

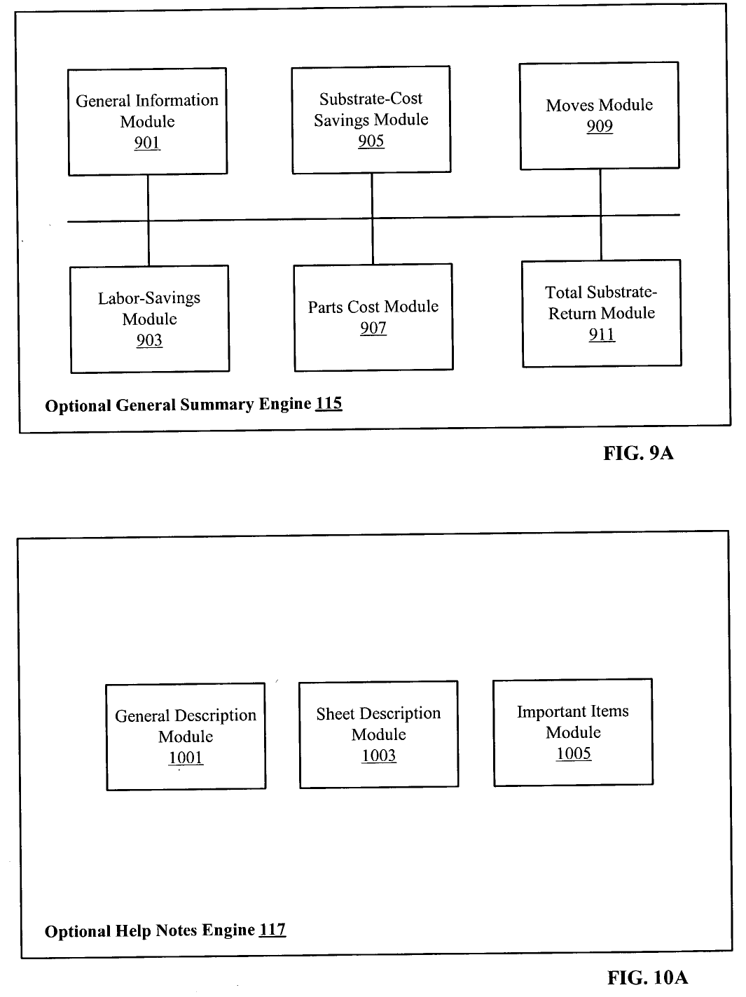

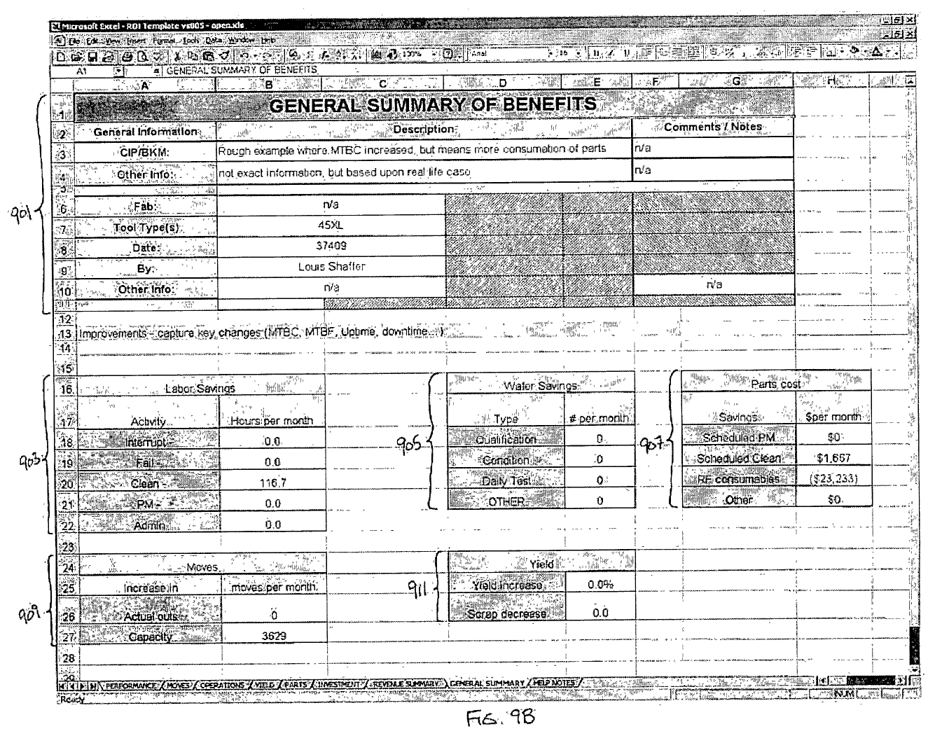

FIG. 9A is an exemplary block diagram of the optional general summary engine 115 of FIG. 1. The optional general summary engine 115 displays user or fab information in a general information module 901, the two major subgroups of operational savings in a labor-savings module 903 and a substrate-cost savings module 905, an overall parts-savings in parts cost module 907, any change in periodic substrate moves in a moves module 909, and any yield change and scrap reduction in a total substrate-return module 911.

FIG. 9B shows a screen shot of an exemplary embodiment of the optional general summary engine 115 of FIG. 1 in the form of a Microsoft® Excel spreadsheet and shows details of calculated values. Calculations displayed within this embodiment of the optional general summary engine 115 have been previously described in connection with calculations performed within other engines of the FIG. 1 embodiment of the present invention. FIG. 9B includes an exemplary general information module 901, an exemplary labor-savings module 903, an exemplary substrate-cost savings module 905, an exemplary parts cost module 907, an exemplary moves module 909, and an exemplary total substrate-return module 911.

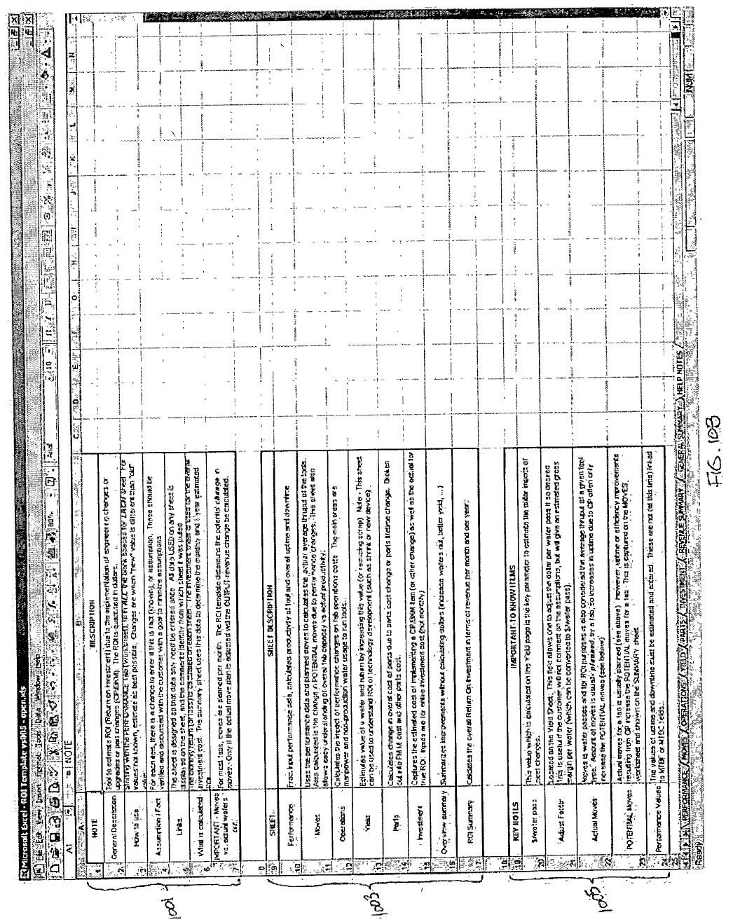

FIG. 10A is an exemplary block diagram of the optional help notes engine 117 of FIG. 1. The optional help notes engine 117 is used to display general information to a user of the system. General information may include overview information on the use of the ROI system 100 (FIG. 1), definitions of less well-known terms, or general indications of how and why calculations are performed. Any of these help notes may be viewed as a textual display, or, optionally, may be in the form of context-sensitive help notes. The optional help notes engine 117 includes a general description module 1001, a sheet description module 1003, and an important items module 1005.

The general description module 1001 lists a general description of the system, the use of the system, a description of various columns, and other general-use descriptions. The sheet description module 1003 describes, in general terms, an overview of each of the various engines of the ROI system 100. The important items module 1005 lists key factors used within various engines and modules of the ROI system 100.

FIG. 10B shows a screen shot of an exemplary embodiment of the help notes engine 117 of FIG. 1 in the form of a Microsoft® Excel spreadsheet and shows examples of informative notes for a user of the ROI system 100. FIG. 10A includes an exemplary general description module 1001, an exemplary sheet description module 1003, and an exemplary important items module 1005.

The exemplary general description module 1001 lists a general description of the system, the use of the system, a description of various columns, and other general-use descriptions. The exemplary sheet description module 1003 describes, in general terms, an overview of each of the various engines of the ROI system 100. The exemplary important items module 1005 lists key factors used within various engines and modules of the ROI system 100.

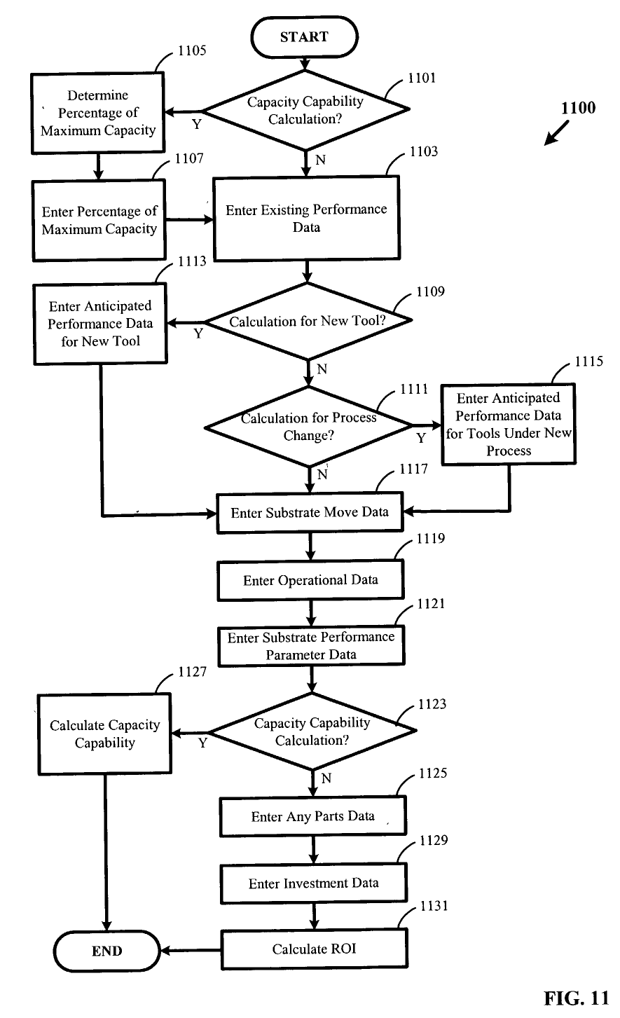

FIG. 11 is a flowchart 1100 of an exemplary method for performing an ROI analysis according to an embodiment of the present invention. Initially, a user is queried as to whether the analysis is to include a capacity capability calculation 1101. If the capacity capability calculation is not to be performed, the user is prompted to enter existing performance data 1103 for an existing tool or fab-line in the exemplary performance engine 101.

If the capacity capability calculation is to be performed, a calculation to determine the percentage of maximum capacity 1105 is performed in the fab capacity module 307 followed by either the user entering the percentage of maximum capacity 1107 or the system automatically entering the percentage value. Next the user is prompted to enter existing performance data 1103 in the exemplary performance engine 101.

Once the existing performance data are entered 1103, the user is queried whether a calculation is to be performed for a new tool 1109. If the user responds the new tool calculation is not to be performed, the user is queried whether a calculation is to be performed for a process change 1111. If the response is the process change calculation 1111 is not to be performed, the user is prompted to enter substrate move data 1117 in the exemplary performance parameters module 301.

If the response to the new tool query affirmatively states the calculation for a new tool 1109 is to be performed, the user is prompted to enter anticipated performance data for the tool 1113 in the exemplary performance engine 101, followed by a prompt to enter substrate move data 1117 in the exemplary performance parameters module 301.

If the response to the new tool query states the calculation for a new tool 1109 is not to be performed and the calculation for a process change 1111 is to be performed, the user is prompted to enter anticipated performance data for tools with the new process 1115 in the exemplary performance engine 101, followed by entering the substrate move data 1117 in the exemplary performance parameters module 301.

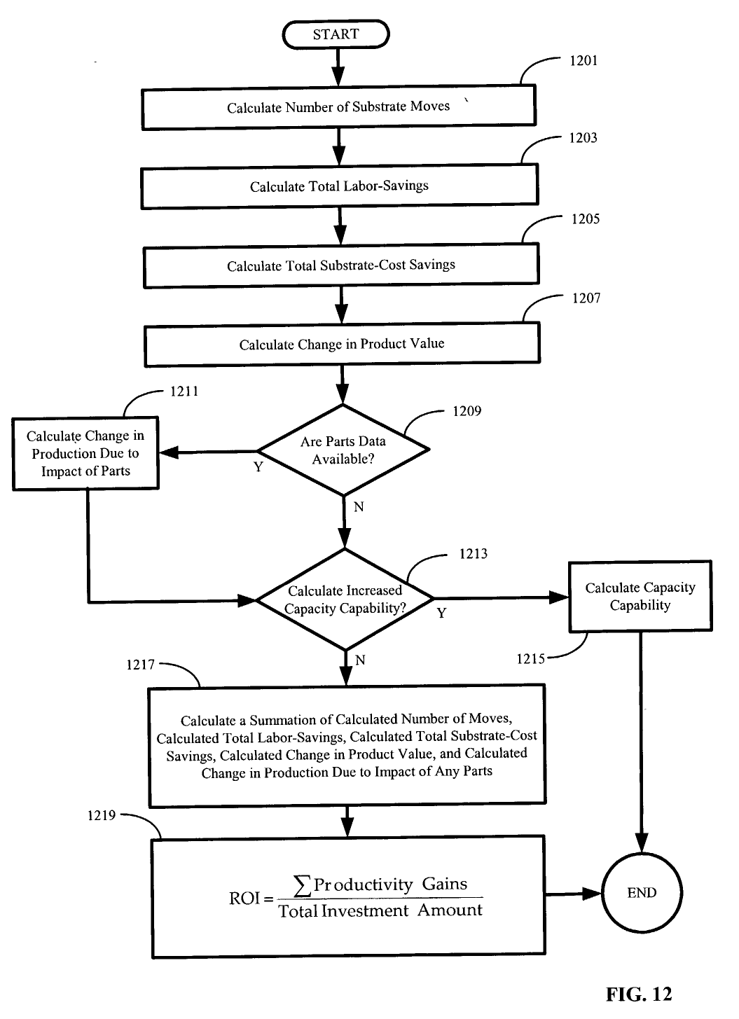

Once the substrate move data are entered 1117 in the exemplary performance parameters module 301, the user is prompted to enter operational data 1119 in the exemplary performance parameters module 401, followed by entering substrate performance parameter data 1121 in the exemplary performance parameters module 501. If the user responded affirmatively in step 1101 that a capacity capability calculation is to be performed, then the system will automatically complete the capacity capability calculation 1127 in exemplary net potential output revenue module 303. If a capacity capability calculation 1123 is not to be performed, then the user is prompted to enter any parts data 1125 in the exemplary performance parameters module 601 and the exemplary consumables table module 605, followed by a prompt for the user to enter investment data 1129 in investments module 701. The ROI system will then calculate a return-on-investment 1131 in the exemplary ROI module 815. Details of the ROI calculation 1131 are given in connection with FIGS. 8B and 12.

FIG. 12 shows an exemplary overview of the calculations performed by the ROI system 100 (FIG. 1) based on data entered in connection with the method shown in FIG. 11. Initially, a calculation is made in the exemplary output revenue increase module 305 of an impact in revenue due to a change in substrate moves 1201, followed by a calculation of total labor-savings 1203 performed in the exemplary labor-cost savings module 405, a calculated total substrate-cost savings 1205 performed in the exemplary substrate-cost savings module 403, and a calculated change in revenue due to a change in product value 1207 performed in the exemplary total substrate-return module 503.

Next, if parts data are not available 1209 (from the exemplary performance parameters module 601 or the exemplary consumables table module 605), and a calculation in increased capacity capability 1213 is not to be performed, a summation is made of productivity gains 1217 due to a calculated impact in revenue due to a change in substrate moves 1201 (from the exemplary output increase module 305), a calculated total labor-savings 1203 (from the exemplary labor-cost savings module 405), a calculated total substrate-cost savings 1205 (from the exemplary substrate-cost savings module 403), a calculated change in revenue due to a change in product value 1207 (from the exemplary total substrate-return module 503), and any calculated change in production due to an impact of parts 1211 (from the exemplary total parts return module 603, further discussed below).

If parts data are available 1209 (from the exemplary performance parameters module 601 or the exemplary consumables table module 605), a calculation is made to determine a change in production due to an impact of parts 1211 in the exemplary total parts return module 603. If a calculation in increased capacity capability 1213 is not to be performed, then a summation of productivity gains 1217 occurs in the exemplary revenue and ROI summary engine 113.

If the user responds that a calculation in increased capacity capability 1213 is to be performed, a calculation of capacity calculation 1215 is performed in the exemplary fab capacity module 307.

Once a summation of productivity gains 1217 is performed in the exemplary revenue and ROI summary engine 113, an ROI calculation is performed 1219 in the exemplary ROI module 815 by dividing the summation of productivity gains performed in step 1217 by the entered total investment amount (e.g., where components of the total investment are entered in the exemplary investments module 701 and the total investment amount is calculated in the exemplary total project investment module 703).

The present invention has been described above with reference to specific embodiments. It will be apparent to one skilled in the art that various modifications may be made and other embodiments can be used without departing from the broader scope of the present invention. For example, although the present invention has been described in terms of a deposition or etch tool, it would be obvious to one skilled in the art to modify the present invention for any other type of processing or metrology tool.

What is claimed is:

1. A system for determining a return-on-investment for a production tool change or an upgraded production tool in a semiconductor or data storage fabrication facility, comprising:
a moves engine configured to calculate a change in output revenue;
an operations engine configured to calculate a change in total operations expense;
a substrate-value engine configured to calculate a change in total substrate revenue;
a parts engine configured to calculate a change in total parts expense;
an investment engine configured to calculate a total investment amount; and
a revenue summary engine configured to calculate a productivity gain by summing the change in output revenue, the change in total operations expense, the change in total substrate revenue, and the change in total parts expense, the revenue summary engine further configured to calculate the return-on-investment by dividing the productivity gain by the total investment amount.

2. The system of claim 1, further comprising a performance engine configured to calculate a change in productivity.

3. The system of claim 2, wherein the performance engine is configured to calculate the change in productivity based on entered performance data.

4. The system of claim 3, wherein the moves engine is configured to calculate the change in output revenue based on entered moves data, a subset of the change in productivity, a subset of values calculated by the substrate-value engine, and a subset of entered substrate performance parameter data.

5. The system of claim 1, wherein the moves engine is configured to calculate the change in output revenue based on entered moves data, a subset of entered performance data, a subset of values calculated by the substrate-value engine, and a subset of entered substrate performance parameter data.

6. The system of claim 1, wherein the operations engine is configured to calculate the change in total operations expense based on entered operations data, a subset of values calculated by the moves engine, a subset of entered moves data, and a subset of entered performance data.

7. The system of claim 1, wherein the substrate-value engine is configured to calculate the change in total substrate revenue based on entered substrate performance parameter data, a subset of entered moves data, and a subset of values calculated by the moves engine.

8. The system of claim 1, wherein the parts engine is configured to calculate the change in total parts expense based on entered parts data, a subset of entered moves data, a subset of entered operations data, a subset of entered performance data, a subset of values calculated by the moves engine, and a subset of values calculated by the operations engine.

9. The system of claim 1, wherein the investment engine is configured to calculate the total investment amount based on entered investment data, a subset of values calculated by the moves engine, a subset of entered substrate performance parameter data, and a subset of entered operations data.

10. The system of claim 1, wherein the system is implemented in hardware.

11. A system for determining a return-on-investment in a semiconductor or data storage fabrication facility, comprising:
a moves engine configured to calculate a change in output revenue;
an operations engine configured to calculate a change in total operations expense;
a substrate-value engine configured to calculate a change in total substrate revenue;
a parts engine configured to calculate a change in total parts expense;
an investment engine configured to calculate a total investment amount; and
a revenue summary engine configured to calculate a productivity gain by summing the change in output revenue, the change in total operations expense, the change in total substrate revenue, and the change in total parts expense, the revenue summary engine further configured to calculate the return-on-investment by dividing the productivity gain by the total investment amount.

12. The system of claim 11, further comprising a performance engine configured to calculate a change in productivity.

13. The system of claim 12, wherein the performance engine is configured to calculate the change in productivity based on entered performance data.

14. The system of claim 13, wherein the moves engine is configured to calculate the change in output revenue based on entered moves data, a subset of the change in productivity, a subset of values calculated by the substrate-value engine, and a subset of entered substrate performance parameter data.

15. The system of claim 12, wherein the moves engine is configured to calculate the change in output revenue based on entered moves data, a subset of entered performance data, a subset of values calculated by the substrate-value engine, and a subset of entered substrate performance parameter data.

16. The system of claim 15, wherein the moves engine configured to calculate the change in output revenue is further based on a calculated change in capacity capability.

17. The system of claim 11, wherein the operations engine is configured to calculate the change in total operations expense based on entered operations data, a subset of values calculated by the moves engine, a subset of entered moves data, and a subset of entered performance data.

18. The system of claim 11, wherein the substrate-value engine is configured to calculate the change in total substrate revenue based on entered substrate performance parameter data, a subset of entered moves data, and a subset of values calculated by the moves engine.

19. The system of claim 11, wherein the parts engine is configured to calculate the change in total parts expense based on entered parts data, a subset of entered moves data, a subset of entered operations data, a subset of entered performance data, a subset of values calculated by the moves engine, and a subset of values calculated by the operations engine.

20. The system of claim 11, wherein the investment engine is configured to calculate the total investment amount based on entered investment data, a subset of values calculated by the moves engine, a subset of entered substrate performance parameter data, and a subset of entered operations data.

21. The system of claim 11, wherein the system is implemented in hardware.

22. The system of claim 11, wherein the return-on-investment is for a split-lot test.

23. The system of claim 11, wherein the return-on-investment is for a short-loop test.

24. The system of claim 11, wherein the return-on-investment is for a process change.

25. A system for determining a return-on-investment for a production tool change or an upgraded production tool in a semiconductor or data storage fabrication facility, comprising:
a means for calculating a change in output revenue;
a means for calculating a change in total operations expense;
a means for calculating a change in total substrate revenue;
a means for calculating a change in total parts expense;
a means for entering investment data and calculating a total investment amount; and
a means for calculating a productivity gain by summing the change in output revenue, the change in total operations expense, the change in total substrate revenue, and the change in total parts expense, the means for calculating the productivity gain further calculating the return-on-investment by dividing the productivity gain by the total investment amount.

26. The system of claim 25, further comprising a means for entering current and anticipated performance data and calculating a change in productivity.

27. A computer readable medium having embodied thereon a program, the program being executable by a machine to perform method steps for determining a return-on-investment for a production tool change or an upgraded production tool in a semiconductor or data storage fabrication facility, the method comprising:
entering substrate moves data;
calculating a change in output revenue;
entering operations data;
calculating a change in total operations expense;
entering substrate performance parameter data;
calculating a change in total substrate revenue;
entering any parts data;
calculating a change in total parts expense;
entering investment data;
calculating a total investment amount;
calculating a productivity gain by summing the change in output revenue, the change in total operations expense, the change in total substrate revenue, and the change in total parts expense; and
calculating a return-on-investment by dividing the productivity gain by the total investment amount.

28. The computer readable medium of claim 27, wherein the executable program method steps further comprise:
entering performance data for existing tools in a semiconductor or data storage production line;
entering anticipated performance data for the production tool change or upgraded production tool in the semiconductor or data storage production line; and
calculating a change in productivity based on the production tool change or the upgraded production tool.

29. A computer readable medium having embodied thereon a program, the program being executable by a machine to perform method steps for determining a return-on-investment in a semiconductor or data storage fabrication facility, the method comprising:
entering substrate moves data;
calculating a change in output revenue;
entering operations data;
calculating a change in total operations expense;
entering substrate performance parameter data;
calculating a change in total substrate revenue;
entering any parts data;
calculating a change in total parts expense;
entering investment data;
calculating a total investment amount;
calculating a productivity gain by summing the change in output revenue, the change in total operations expense, the change in total substrate revenue, and the change in total parts expense; and
calculating a return-on-investment by dividing the productivity gain by the total investment amount.

30. The computer readable medium of claim 29, wherein the executable program method steps further comprise:
entering performance data for existing tools in a semiconductor or data storage production line;
entering anticipated performance data for the semiconductor or data storage production line; and
calculating a change in productivity.

31. The computer readable medium of claim 29, wherein the executable program method calculates the return-on-investment for a split-lot test.

32. The computer readable medium of claim 29, wherein the executable program method calculates the return-on-investment for a short-loop test.

33. The computer readable medium of claim 29, wherein the executable program method calculates the return-on-investment for a process change.

34. The computer readable medium of claim 29, wherein the executable program method calculates the change in output revenue based on a calculated change in capacity capability.

35. A method for determining a return-on-investment for a production tool change or an upgraded production tool in a semiconductor or data storage fabrication facility, the method comprising:
entering substrate moves data;
calculating a change in output revenue;
entering operations data;
calculating a change in total operations expense;
entering substrate performance parameter data;
calculating a change in total substrate revenue;
entering any parts data;
calculating a change in total parts expense;
entering investment data;
calculating a total investment amount;
calculating a productivity gain by summing the change in output revenue, the change in total operations expense, the change in total substrate revenue, and the change in total parts expense; and
calculating a return-on-investment by dividing the productivity gain by the total investment amount.

36. The method of claim 35, further comprising:
entering performance data for existing tools in a semiconductor or data storage production line;
entering anticipated performance data for the production tool change or upgraded production tool in the semiconductor or data storage production line; and
calculating a change in productivity values based on the production tool change or upgraded production tool.

37. The method of claim 36, wherein calculating the change in output revenue is based on a subset of the change in productivity values, entered substrate moves data, entered substrate performance parameter data, and entered performance data.

38. The method of claim 35, wherein calculating the change in total operations expense is based on entered operations data, entered substrate moves data, and entered performance data.

39. The method of claim 35, wherein calculating the change in total substrate revenue is based on entered substrate performance parameter data and entered substrate moves data.

40. The method of claim 35, wherein calculating the change in total parts expense is based on entered parts data, entered substrate moves data, entered operations data, and entered performance data.

41. The method of claim 35, wherein calculating the total investment amount is based on entered investment data, entered substrate moves data, entered substrate performance parameter data, and entered operations data.

42. A method for determining a return-on-investment in a semiconductor or data storage fabrication facility, the method comprising:
entering substrate moves data;
calculating a change in output revenue;
entering operations data;
calculating a change in total operations expense;
entering substrate performance parameter data;
calculating a change in total substrate revenue;
entering any parts data;
calculating a change in total parts expense;
entering investment data;
calculating a total investment amount;
calculating a productivity gain by summing the change in output revenue, the change in total operations expense, the change in total substrate revenue, and the change in total parts expense; and
calculating a return-on-investment by dividing the productivity gain by the total investment amount.

43. The method of claim 42, further comprising:
entering performance data for existing tools in a semiconductor or data storage production line;
entering anticipated performance data for the semiconductor or data storage production line; and
calculating a change in productivity.

44. The method of claim 43, wherein calculating the change in output revenue is based on a subset of the change in productivity, entered substrate moves data, entered substrate performance parameter data, and entered performance data.

45. The method of claim 42, wherein calculating the change in total operations expense is based on entered operations data, entered substrate moves data, and entered performance data.

46. The method of claim 42, wherein calculating the change in total substrate revenue is based on entered substrate performance parameter data and entered substrate moves data.

47. The method of claim 42, wherein calculating the change in total parts expense is based on entered parts data, entered substrate moves data, entered operations data, and entered performance data.

48. The method of claim 42, wherein calculating the total investment amount is based on entered investment data, entered substrate moves data, entered substrate performance parameter data, and entered operations data.

49. The method of claim 42, wherein the return-on-investment calculation is for a split-lot test.

50. The method of claim 42, wherein the return-on-investment calculation is for a short-loop test.

51. The method of claim 42, wherein the return-on-investment calculation is for a process change.

52. The method of claim 42, wherein calculating the change in output revenue is further based on a calculated change in capacity capability.
